(19) United States
(12) Patent Application Publication
(10) Pub. No.: US 2008/0011558 A1
(43) Pub. Date: Jan. 17, 2008

(54) GUIDE RAIL FOR ELEVATOR

(76) Inventor: Jose Carlos Lusquinos, Sao Paulo (BR)

Correspondence Address: William J. Clemens, Esq.;Fraser Clemens Martin & Miller LLC, 28366 Kensington Lane, Perrysburg, OH, 43551-4163, US

(21) Appl. No.: 11/774,155

(22) Filed: Jul. 6, 2007

(30) Foreign Application Priority Data
Jul. 7, 2006 (EP) 06116860.5

(51) Int. Cl. B66B 7/02

(52) U.S. Cl. 187/406

(57) ABSTRACT

Guide rail for elevator installations comprising a blade (10) with two juxtaposed layers (10′) and (10″) and a base (20) with two lateral portions (20′) and (20″) made of a first bent sheet (1), wherein a second sheet (2) is juxtaposed to the first bent sheet (1) at the base (20) of the guide rail so as to increase the guide rail stiffness and to reinforce the base (20).

Present invention concerns a guide rail for elevator installations.

Cabin and counterweight guide rails are critical component of an elevator installation. Some elevator installations use cabin and counterweight guide rails manufactured of a single bent steel sheet in order to reduce the cost of this component. The counterweight guide rail manufactured in this way has a low cost, when compared with a regular and traditional solid cold rolled steel guide rail. However, this process of guide rail manufacturing presents a shortcoming, since the stiffness of this type of guide rail is reduced due to the low moment of inertia. Another disadvantage of this traditional guide rail is the possibility to deform if not properly attached in the installation menacing the elevator safety.

The object of the present invention is therefore to provide a guide rail for elevator installations, which does not exhibit the above-mentioned shortcomings. The object of the present invention is, in particular, to provide a guide rail for elevator installations with low cost and high stiffness (increased moment of inertia) to ensure stability even in abnormal situations.

The problem of this invention is solved as set out in claim 1, whereby a guide rail for elevator installations comprising a blade with two juxtaposed layers and a base with two lateral portions made of a first bent sheet exhibits a second sheet juxtaposed to the first bent sheet at the base of the guide rail, so as to increase the guide rail stiffness and to reinforce the base.

Such a guide rail exhibits the advantages of low cost, since it can be manufactured with cheap steel sheets, and also of high stiffness due to the second reinforcing sheet, which is assembled at the base of the guide rail. The second sheet, preferably of steel, can be pre-shaped in order to increase its stiffness before being assembled into the guide rail assembly.

In a preferred embodiment of the invention the second sheet connects and/or bridges and/or keeps in place the two lateral portions of the base. The base is the weakest point of the guide rail and a reinforcement at this point can dramatically increase the moment of inertia and the stiffness of the guide rail without increasing the weight and the costs of the whole guide rail assembly.

In a further preferred embodiment of the invention the second sheet provided to the first bent sheet on the base of the guide rail exhibits a protrusion at the intersection between the blade and the base oriented in direction opposite of the blade or oriented towards the blade.

These embodiments exhibit the advantage that the stiffness of the guide rail is tremendously increased in the longitudinal direction when the guide rail is charged by a horizontal force perpendicular to the base of the guide rail. This positive effect is achieved by the presence of the protrusion and does not require a higher weight and cost of the whole guide rail assembly. The protrusion increases the moment of inertia of the guide rail around the horizontal axis passing through the base of the guide rail.

For a more complete description of the present invention reference is made to the following description, taken in conjunction with the accompanying drawings, in which:

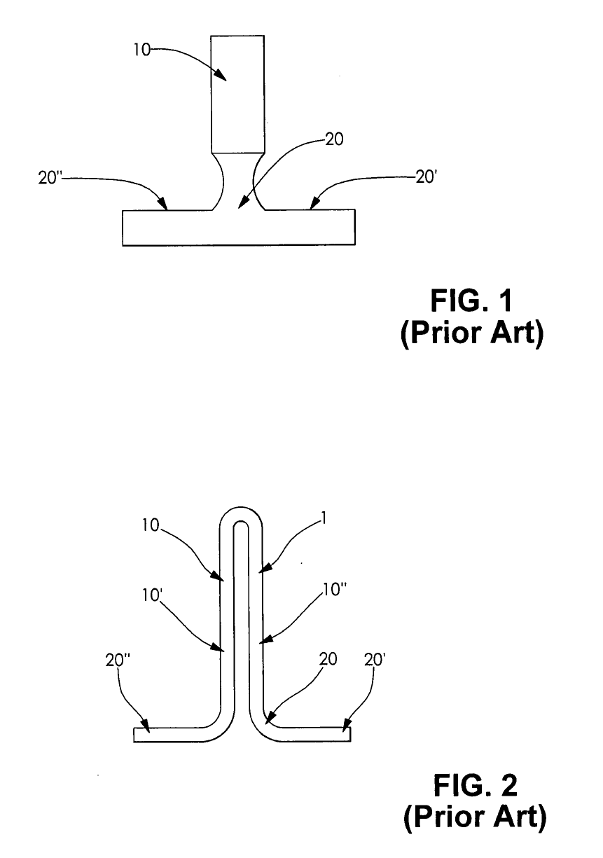

FIG. 1 represents a guide rail manufactured with a cold rolled steel according to the state of the art;

FIG. 2 represents a guide rail made of a bent single steel sheet, manufactured according to the state of the art;

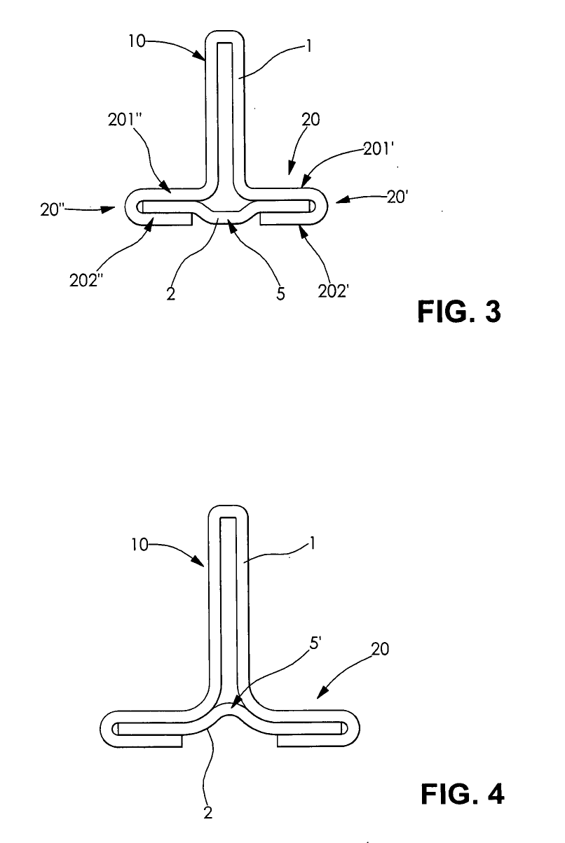

FIG. 3 represents a guide rail according to a preferred embodiment of the present invention, whereby the guide rails is manufactured with two pieces of steel sheet;

FIG. 4 represents a guide rail according to a second preferred embodiment of the present invention, whereby the guide rail is manufactured with two pieces of steel sheet and the second steel sheet at the base of the guide rail exhibits a protrusion oriented towards the blade of the guide rail.

FIG. 1 shows a guide rail according to the state of the art made with cold rolled steel characterized by high stiffness, but also by a high cost. The guide rail is T-shaped with a blade 10 in sliding contact with the elevator cabin and with a base 20 consisting in two lateral portion 20′ and 20″ used to attach the guide rail to the elevator shaft. This guide rail is made as unique piece of cold rolled steel. It is therefore very resistant and stiff in all directions, but it is heavy and expensive.

On the other hand, FIG. 2 shows a bent steel sheet guide rail according to the state of the art. The blade 10 and the base 20 of such a guide rail are produced by bending a unique steel sheet 1 to a T-shaped geometry, which is shown in FIG. 2. According to this production method the base 20 of the guide rail consists of two lateral portions 20′ and 20″ made of a single layer of the steel sheet 1. The blade 10 of the guide rail consists of two juxtaposed layers 10′ and 10″ of the bent steel sheet 1, which can be separated by a hollow space like in FIG. 2 or also lie one beside the other. As it can be seen in FIG. 2, the region of the guide rail at the intersection between the blade 10 and the base 20 is particularly weak. Also the base 20 of the guide rail is a weak point of the construction, since it consists of only two thin lateral portions 20′ and 20″ made of a single layer of the steel sheet. The guide rail exhibits therefore a low moment of inertia, a low stiffness and a low resistance, in particular in respect to horizontal forces perpendicular to the base of the guide rail. In case of an abnormal operation of the elevator, the guide rails can be deformed damaging the elevator car.

FIG. 3 shows a preferred embodiment of the present invention, whereby the guide rail is manufactured with two steel sheets, a first bent steel sheet 1 and a second reinforcement sheet 2 at the guide rail base 20. The first bent steel sheet 1 forms the two juxtaposed layers 10′ and 10″ of the blade 10 and the two lateral portions 20′ and 20″ of the base 20.

The second reinforcement sheet 2, preferably of steel, is provided to the base 20 of the T-shaped guide rail and is juxtaposed to the two lateral portions 20′ and 20″ of the base 20 connecting and bridging them, so that the resistance, the moment of inertia and the stiffness of this point, i.e. the region separating the two lateral portions 20′ and 20″, is dramatically increased.

Since the two lateral portions 20′ and 20″ of the base 20 are connected and kept together by the second sheet 2, the resistance, the moment of inertia and the stiffness of the guide rail assembly is dramatically increased, in spite of the fact that its weight and cost increase only slightly.

In order to keep the second sheet 2 in its position, the two lateral portions 20′ and 20″ of the base 20 made up by the first bent sheet 1 are preferably bent in a U-shape, as shown in FIG. 3, so that the extremities of the second sheet 2 are inserted and retained by the two branches of the U formed by the first bent sheet 1.

In FIG. 3 the left extremity of the second sheet 2 is for example inserted and retained by the branches 201″ and 202″ of the U in which the first sheet 1 has been bent at the lateral portion 20″, while the right extremity of the second sheet 2 is inserted and retained by the branches 201′ and 202′ of the U in which the first sheet 1 has been bent at the lateral portion 20′.

The reinforcing metal sheet 2 exhibits preferably at the intersection of the base 20 with the blade 10 a protrusion 5 oriented in direction opposite of the blade 10, as shown in FIG. 3.

In such a way the resistance, the moment of inertia and the stiffness of the guide rail assembly are further increased, above all in respect of horizontal forces acting in a direction perpendicular to the base 20. The protrusion increases the moment of inertia of the guide rail around the horizontal axis passing through the base of the guide rail.

FIG. 4 shows an alternative embodiment of the invention, whereby the reinforcing metal sheet 2 exhibits at the intersection of the base 20 with the blade 10 a protrusion 5′ oriented towards the blade 10. Also in this case the resistance, the moment of inertia and the stiffness of the guide rail assembly are further increased, above all in respect of horizontal forces acting in a direction perpendicular to the base 20.

The shape of the second sheet 2 fixed to the first bent metal sheet can be modified depending of the expected and desired effects. The guide rails according to the invention are manufactured by simply bending in different shapes two metal sheets. Their production method does not require therefore complex machinery and is not expensive.

1. Guide rail for elevator installations comprising a blade (10) with two juxtaposed layers (10′) and (10″) and a base (20) with two lateral portions (20′) and (20″) made of a first bent sheet (1), characterized in that a second sheet (2) is juxtaposed to the first bent sheet (1) at the base (20) of the guide rail so as to increase the guide rail stiffness and to reinforce the base (20).

2. Guide rail for elevator installations according to claim 1, wherein the second sheet (2) connects and/or bridges and/or keeps in place the two lateral portions (20′) and (20″) of the base (20).

3. Guide rail for elevator installations according to claim 2, wherein the second sheet (2) provided to the first bent sheet (1) on the base (20) of the guide rail exhibits a protrusion (5) at the intersection between the blade (10) and the base (20) oriented in direction opposite to the blade (10).

4. Guide rail for elevator installations according to claim 2, wherein the second sheet (2) provided to the first bent sheet (1) on the base (20) of the guide rail exhibits a protrusion (5′) at the intersection between the blade (10) and the base (20) oriented towards the blade (10).

5. Guide rail for elevator installations according to any of the preceding claims, wherein the first bent sheet (1) and/or the second sheet (2) are made of steel.

6. Elevator installation with a guide rail according to any of the preceding claims.

7. Elevator installation according to claim 6, wherein a guide rail according to any of the claims 1 to 5 is used for the counterweight guide rail.
